(19) United States
(12) Patent Application Publication
(10) Pub. No.: US 2025/0193591 A1
(43) Pub. Date: Jun. 12, 2025

(54) UNDERWATER COMMUNICATION DEVICE

(71) Applicant: INSPIRIT VENTURES INC., Gwangju (KR)

(72) Inventor: Seung Il JUNG, Gwangju (KR)

(21) Appl. No.: 18/282,075

(22) PCT Filed: Aug. 21, 2023
(86) PCT No.: PCT/KR2023/012330

§ 371 Date: Dec. 12, 2024

(30) Foreign Application Priority Data
Aug. 22, 2022 (KR) 10-2022-0104576
Apr. 20, 2023 (KR) 10-2023-0052096

(51) Int. Cl. H04R 1/44; B63C 11/26

(52) U.S. Cl. CPC H04R 1/44; B63C 11/26

(57) ABSTRACT

Proposed is an underwater communication device. The underwater communication device is configured to enable accurate communication between divers by transmitting voices using water as a medium and by allowing a diver to pronounce bilabial consonants while breathing when the diver speaks underwater so that other divers can hear the speech.

### TECHNICAL FIELD

The present disclosure relates to an underwater communication device and, more particularly, to a simple underwater communication device that enables accurate communication between divers by transmitting voices using water as a medium and by allowing a diver to pronounce bilabial consonants while breathing when the diver speaks underwater so that other divers can hear same.

### BACKGROUND ART

Marine sports have evolved into many different forms of entertainment.

As one example, people have enjoyed scuba diving for physical training and underwater exploration since scuba diving was invented in 1943, and the popularity of scuba diving is growing rapidly day by day as more scuba diving clubs are established and more places for scuba diving are selected as recommended travel destinations.

The maximum depth of diving by scuba diving is about 30 to 40 m, and the diving time is about three and a half hours, but when descending deeply the diving time has to be reduced since water pressure is higher. Otherwise, the human body may not be able to adapt, thereby losing consciousness or even dying.

Meanwhile, it is impossible in scuba diving to communicate with other divers through voices since a diver breathes while holding a mouthpiece in his/her mouth so divers communicate with each other with a predetermined body motion. Such communication through body motion (body language-sign language) has limitations, and in particular, there may be a life-threatening problem when communication is not well performed in emergencies.

Therefore, there is a need for an underwater communication device that enables divers to easily communicate with each other verbally underwater.

In addition, FIG. 4 is a drawing showing the conventional mouthpiece 10.

Referring to FIG. 4, the conventional mouthpiece 10 is for a diver holding in his/her mouth and inhaling air underwater and includes a fastening part 11 which is cylindrical with an air inlet 12 being penetrated in the center and one end of whose is fastened with a second respirator 50, a guide wing part 14 which extends from each of opposite sides of the other end of the fastening part 11 and is inserted in between the inner side of cheeks and teeth when being bitten by a diver, and a tooth occlusion part 13 which protrudes from the inner surface of each of the guide wing part 14 and which prevents the guide wing parts 14 from escaping from the oral cavity when a diver holds in his/her mouth with the lower teeth and the upper teeth.

Meanwhile, when a diver holds the conventional mouthpiece 10 in his/her mouth, the lips surround the outer circumference of the fastening part 11 and the teeth bite the tooth occlusion part 13. In this case, the diver may pronounce a front vowel made between the front of the tongue and the hard palate such as ‘⊏(d,t), [symbol] (tt), ∈(t), [symbol] (j), [symbol] (jj), [symbol] (ch), [symbol] (s), [symbol] (ss), [symbol] (n), [symbol] (r,l)’, a back vowel made between the back of the tongue and the soft palate such as ‘¬(g,k), [symbol] (kk), [symbol] (k), o(ng)’, and a glottal sound made by blocking or rubbing the vocal cords such as ‘ [symbol] (h)’, but may not pronounce a bilabial consonant being made between the lips or being made when the front teeth touch the inner side of lips such as ‘ [symbol] (b,p), [symbol] (pp), [symbol] (p), □(m)’.

That is, there is a problem in which a diver may not communicate verbally through voices with other divers since the diver may not pronounce bilabial consonants underwater in a state of holding a mouthpiece in his/her mouth and breathing.

### DISCLOSURE

### Technical Problem

The present disclosure is devised to solve the described problem, and an objective of the present disclosure is to provide an underwater communication device that enables divers to simply communicate through voices underwater.

In addition, another objective of the present disclosure is to provide an underwater communication device that adjusts the volume of the transmitted voice depending on the distance between divers.

In addition, another objective of the present disclosure is to provide an underwater communication device that selectively performs either breathing or transmitting voice through a mouthpiece using a switch gear.

In addition, another objective of the present disclosure is to provide an underwater communication device with a mouthpiece that enables divers to communicate through voices underwater by articulately pronouncing bilabial consonants while holding the mouthpiece in his/her mouth.

### Technical Solution

To achieve the objectives, the present disclosure proposes an underwater communication device in which the other diver may hear voices transmitted through water when one diver speaks while holding same in his/her mouth, and include: a casing which forms an interior space and has openings respectively provided on one side and the other side thereof; a voice transmission member which is provided on one opening of the casing and transmits voices into the interior space of the casing when a diver holds same in his/her mouth and speaks; and a vibration member which is in the shape of a horn with one side of a large diameter being opened and with the other side being closed, the other side of which is inserted into the other opening of the casing, one side end outer circumference of which is screwed into the other opening inner circumference of the casing, and which transmits voices into the other side being opened by vibrating through voices transmitted into the interior space of the casing. The underwater communication device is characterized in that the vibration member may change the volume of the interior space of the casing by moving back and forth depending on the extent of screwing one side end outer circumference to the other opening inner circumference of the casing and the volume of the transmitted voice is changeable as the volume of the interior space of the casing is changeable.

In a preferable exemplary embodiment, the vibration member includes a horn-shaped skeleton frame, a carbon fiber plate that surrounds the outer circumference of the skeleton frame and vibrates by voice, and a guide rod that extends backward from the other side of the skeleton frame and is inserted into a guide hole inside the casing so as not to be shaken when the skeleton frame and the carbon fiber plate move forward and backward.

In a preferable exemplary embodiment, the interior space of the casing includes the vibration member, a voice transmission space which transmits voices, an air emission space which emits air of the voice transmission space to the outside when the pressure of the voice transmission space is more than a predetermined level of pressure, and a valve which emits air more than a predetermined level of pressure between the voice transmission space and the air emission space, and the air emission space is provided with an air outlet that emits air to the outside and a mesh net that crushes air flowing into the air emission space into fine bubbles and emits the bubbles underwater.

In a preferable exemplary embodiment, the underwater communication device fastens with a mouthpiece connection adaptor connecting a mouthpiece that a diver holds in his/her mouth while being supplied with air and a second respirator that supplies the mouthpiece with the air of the air tank, and the mouthpiece connection adaptor is provided with a switch gear which selectively supplies the mouthpiece with the air of the second respirator or supplies the voice transmission member with the air spit when a diver speaks.

In addition, the mouthpiece enables a diver to speak underwater while breathing and includes: a fastening part which is cylindrical with an air inlet being penetrated through which air may flow from one side to the other side and whose one end fastens either with a second respirator which receives air from a first respirator of an air tank and then emits or with the mouth connection adaptor; a guide wing part which extends from each of opposite sides of the other end of the fastening part and may be inserted in between the inner side of a diver's cheeks and teeth; a tooth occlusion part which protrudes from the inner surface of the guide wing part and which a diver may hold in his/her mouth with the lower teeth and the upper teeth when the guide wing parts are inserted into the oral cavity so as not to escape from the oral cavity; and a lip biting tube which extends with a predetermined length from the other end of the fastening part, which supplies the air from the fastening part to the oral cavity of a diver, and which enables to pronounce bilabial consonants (labial sounds) by placing the upper teeth on the inner side of the lower lip whereas breathing while holding with lips when a diver spits the guide wing part toward the outside of the oral cavity underwater.

### Advantageous Effects

The present disclosure has the following effects.

According to an underwater communication device of the present disclosure, there is an advantage that the other diver may hear the voices transmitted through a vibration member when a diver simply holds the underwater communication device in his/her mouth and speaks.

In addition, according to the underwater communication device of the present disclosure, the efficiency of voice transmission may be maximized by adjusting the volume or the wavelength of the transmitted voices depending on the distance between divers since the volume of and the pressure of a voice transmission space inside the casing may be changeable.

In addition, according to the underwater communication device of the present disclosure, there is an advantage that it is possible to transmit voices underwater through the underwater communication device even when a diver holds a mouthpiece in his/her mouth and speaks through a mouthpiece connection adaptor without spitting out the mouthpiece for breathing.

In addition, according to the underwater communication device of the present disclosure, there is an advantage that divers may communicate through an accurate voice while breathing underwater since bilabial consonants may be articulately pronounced by placing the upper front teeth on the inner side of the lower lip after spitting a guide wing part of the mouthpiece out of the oral cavity and holding a lip biting tube with lips underwater.

### BRIEF DESCRIPTION OF THE DRAWINGS

FIG. 1 is a view of an underwater communication device according to an exemplary embodiment of the present disclosure;

FIG. 2 is a cross-sectional view showing the inside of an underwater communication device according to an exemplary embodiment of the present disclosure;

FIG. 3 is a view for explaining that an underwater communication device according to an exemplary embodiment of the present disclosure connects to a mouthpiece using a mouthpiece connection adaptor;

FIG. 4 is a view of a conventional mouthpiece;

FIG. 5 is a view showing a mouthpiece of an underwater communication device according to an exemplary embodiment of the present disclosure;

FIG. 6 is a view for explaining a state that a mouthpiece of an underwater communication device according to an exemplary embodiment of the present disclosure is held in his/her mouth only for respiration;

FIG. 7 is a view for explaining a state that a mouthpiece of an underwater communication device according to an exemplary embodiment of the present disclosure is held in his/her mouth for both respiration and vocalization.

Description of Reference Numerals

| | |
|---|---|
| 100: | underwater communication device |
| 110: | casing |
| 113: | interior space of the casing |
| 113a: | voice transmission space |
| 133b: | air emission space |
| 113aa: | valve |
| 114: | air outlet |
| 115: | mesh net |
| 120: | voice transmission member |
| 130: | vibration member |
| 133: | skeleton frame |
| 134: | carbon fiber plate |
| 200: | mouthpiece connection adaptor |
| 300: | mouthpiece |
| 310: | lip biting tube |

### BEST MODE

The terms used in the present disclosure are selected from general terms that are currently as widely used as possible, but in certain cases, some terms are arbitrarily selected by the applicant, and in this case, the meaning should be understood in consideration of the meaning described or used in the detailed description of the present disclosure rather than as a simple name of terms.

Hereinafter, the technical composition of the present disclosure will be described in detail with reference to the preferred embodiments shown in the accompanying drawings.

However, the present disclosure is not limited to the embodiments described herein and may be embodied in other forms. The same reference numerals throughout the specification represent the same components.

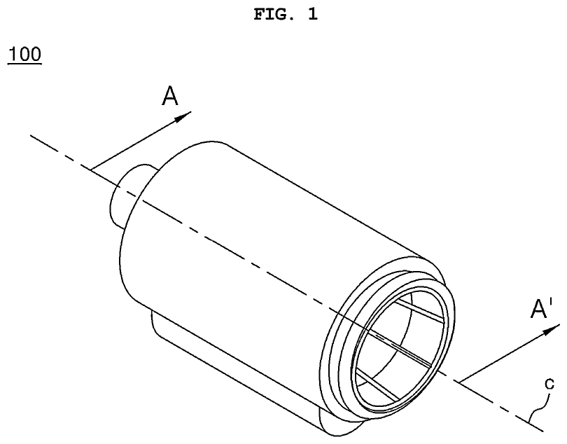

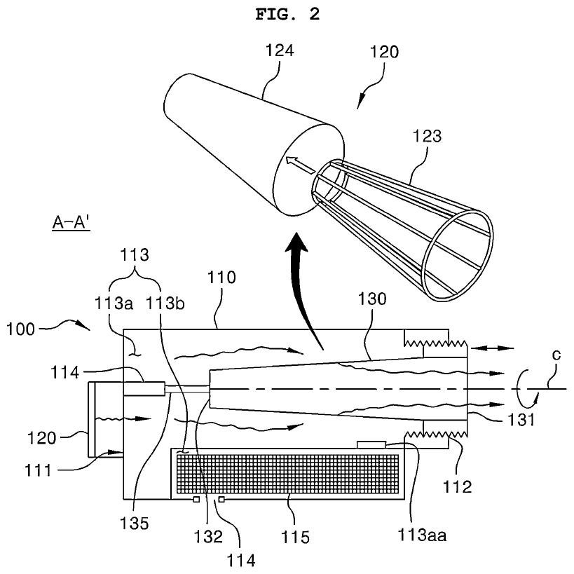

FIG. 1 is a view of an underwater communication device according to an exemplary embodiment of the present disclosure, and FIG. 2 is a cross-sectional view showing the inside of an underwater communication device according to an exemplary embodiment of the present disclosure.

Referring to FIGS. 1 and 2, the underwater communication device 100 according to an exemplary embodiment of the present disclosure is a simple underwater communication device that other divers may listen to voices underwater when vibrations are transmitted through water as a medium when a diver places his or her mouth and speaks while holding with his or her hand or wearing on the wrist with a band.

That is, the underwater communication device 100 according to an exemplary embodiment of the present disclosure is a device transmitting voices without components which use electricity, such as speakers or microphones.

The underwater communication device 100 includes a casing 110, a voice transmission member 120, and a vibration member 130.

The casing 110 is formed with an empty space inside, and each of one side 111 and the other side 112 has an opening.

In addition, there is no particular restriction on the shape although the casing 110 is shown to be manufactured in a cylindrical shape in the drawings.

The voice transmission member 120 is a part which a diver holds in his/her mouth and speaks, and the diver's voice is transmitted to the interior space 113 of the casing 110 when the diver speaks.

A vibration member 130 is in the shape of a horn with one side of a large diameter 131 being opened and with the other side 132 being closed, and the other side 132 is inserted into the other opening 112 of the casing.

In addition, one side end outer circumference of the vibration member 130 is screwed into the other opening 112 inner circumference of the casing 110, and water does not flow in between one side end outer circumference of the vibration member 130 and the other opening 112 inner circumference of the casing 110.

Meanwhile, the extent to which the vibration member 130 is inserted into the inside of the casing 110 is changeable depending on the extent to which screws are rotated and fastened to the casing 110 and thereby the volume of the interior space 113 of the casing is changeable.

That is, there is an advantage of adjusting the volume or the wavelength of voices depending on the distance between divers by varying the volume of the interior space 113 of the casing.

This means that voices may be effectively transmitted even when the distance between divers is far from.

In addition, the vibration member 130 includes a horn-shaped skeleton frame 133 and a vibration plate 130 that surrounds the outer surface of the skeleton frame 133, transmits through vibration voices flowing into the interior space 113 of the casing into water flowing in, and thereby transmits voices underwater.

In addition, as the vibration plate 130 it is preferable to use a carbon fiber plate that may be waterproof and easily vibrate even with small voices.

In addition, on the other side of, that is, on the rear side of the skeleton frame 133, there is a guide rod 135 which extends backward and is inserted into a guide hole 114 of the casing 110 while guiding not to shake when the skeleton frame 1130 and the carbon fiber plate 134 move back and forth.

Meanwhile, the interior space 113 of the casing 110 is divided into a voice transmission space 113a in which the vibration member 130 is located to transmit voices, and an air emission space 113b which emits air from the voice transmission space 113a to the outside.

In addition, in between the voice transmission space 113a and the air emission space 113b is provided a valve 113aa which emits the water and the air of the voice transmission space 113a into the air emission space 113b if more than a predetermined pressure when a diver speaks or blows air into the voice transmission space 113a.

In addition, the valve 113aa serves as a damper that may adjust the volume of the voice transmission space 113a when a diver speaks while the volume of the voice transmission space 113a increases or decreases.

In addition, the valve 113a is replaceable as a combination of a check valve that allows air to pass from the voice transmission space 113a into the air emission space 113b only in one direction and a control valve that controls the amount of air passing through the check valve.

That is, it is possible by the check valve to prevent seawater from flowing back from the air emission space 113b to the voice transmission space 113a, and the extent to which sound pressure is transmitted to the vibration member 130 is changeable by adjusting the emitting level of air through the control valve and then adjusting the pressure of the voice transmission space 113a.

In addition, in the air emission space 113b, there is provided a mesh net 115 in which the sound of water droplets is minimized and which enables clear voice transmission during voice transmission by crushing the air flowing in from the voice transmission space 113a into fine bubbles and then emitting underwater.

In addition, the air crushed by the mesh net 115 is emitted underwater through an air outlet 114.

Meanwhile, a diver may transmit voices into the underwater communication device 100 through the mouthpiece which is held in his/her mouth for respiration without directly holding the underwater communication 100 in his/her mouth.

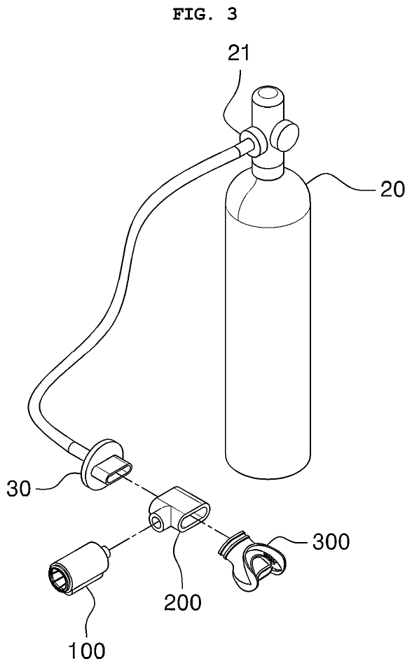

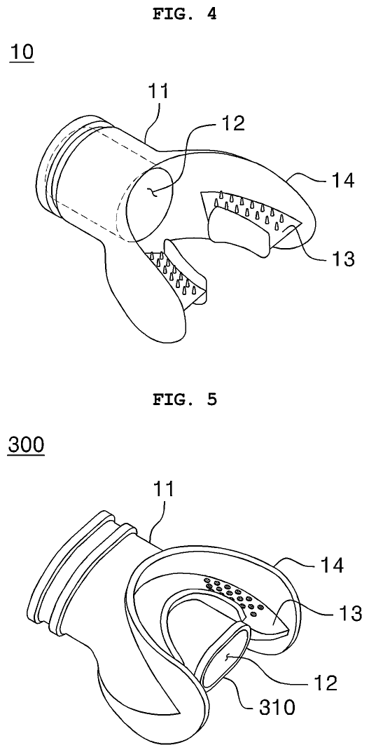

FIG. 3 is a view for explaining that the underwater communication device 100 connects to a mouthpiece 300 using a mouthpiece connection adaptor 200.

Referring to FIG. 3, generally, a diver inhales air from an air tank 20 through a first respirator 21, a second respirator 30, and a mouthpiece 300 in consecutive order, always holding the mouthpiece 300 in his/her mouth.

That is, in order to use the underwater communication device 100, the mouthpiece 300 is spit out and then a voice transmission member 120 of the underwater communication device 100 has to be held in his/her mouth and spoken.

Since inconvenience occurs in this process, in the present disclosure, the mouthpiece connection adaptor 200 is fastened in between the second respirator 30 and the mouthpiece 300, the voice transmission member 120 of the underwater communication device 100 is fastened into the mouthpiece connection adaptor 200, and thereby the voice of a diver holding the mouthpiece 300 in his/her mouth is transmitted into the underwater communication device 100 through the mouthpiece connection adaptor 200.

In addition, inside the mouthpiece connection adaptor 200 is a switch gear (not shown in the drawings) that transmits the air of the second respirator 30 into the mouthpiece 10 or transmits the air spit by a diver when speaking into the underwater communication device 100.

In addition, the switch gear may comprise, for example, a 3-way valve, and the like, and may be replaceable by a variety of valve devices or switching devices known in the related art.

Meanwhile, a diver may pronounce front vowels, back vowels, and glottals while holding the mouthpiece 300 in his/her mouth, but there occurs a problem that the diver may not pronounce bilabial sounds.

Therefore, in the present disclosure, the mouthpiece 300 is configured to pronounce bilabial sounds.

Referring to FIG. 5 for a more detailed description, the mouthpiece 300 of the underwater communication device 100 according to an exemplary embodiment of the present disclosure is a device that a diver may hold the underwater communication device in his/her mouth while inhaling air underwater and includes a fastening part 11, a guide wing part 14, a tooth occlusion part 13, and a lip biting tube 310.

The fastening part 11 is cylindrical in shape with an air inlet 12 being penetrated in the center through which air can flow from one side to the other side, and one end is connected to the second respirator 30 or to the mouthpiece connection adaptor 200 as shown in FIG. 3.

That is, the fastening part 11 is a kind of tube that transfers the air emitted from the second respirator 50 into the oral cavity of a diver.

In addition, although the fastening part 11 is shown in a cylindrical shape, it may be manufactured to be in an elliptical cylinder shape or a square pillar shape.

The guide wing part 14 extends from each of opposite sides of the other end of the fastening part 11 and is inserted into the oral cavity of a diver and between the cheeks and the teeth.

That is, the guide wing part 14 is inserted between both the cheeks and the teeth in the oral cavity.

The tooth occlusion part 13 protrudes from the inner surface of the guide wing part 14, and is a part that a diver may hold with the lower molars and the upper molars when the guide wing part 14 is inserted into the oral cavity.

That is, a diver inserts the guide wing part 14 between both cheeks and the teeth and holds the tooth occlusion part 13 with the lower teeth and the upper teeth so that the mouthpiece 300 may not escape from the oral cavity.

As a core component of the mouthpiece 300, a lip biting tube 310 extends from the other end of the fastening part 11 and protrudes between the guide wing parts 14 in a predetermined length, thereby transmitting the air supplied from the fastening part 11 into the oral cavity of a diver.

In addition, the lip biting tube 110 may be lightly held or touched by the front teeth of a diver, but not held with the lips when the guide wing part 14 is inserted into the inner side of the opposite cheeks of the diver.

Simply, when a diver spits the guide wing part 14 out of the oral cavity the diver may pronounce bilabial sounds by placing the upper teeth on the inner surface of the lower lip in a state in which the lib biting tube is held with lips while holding with lips and breathing underwater.

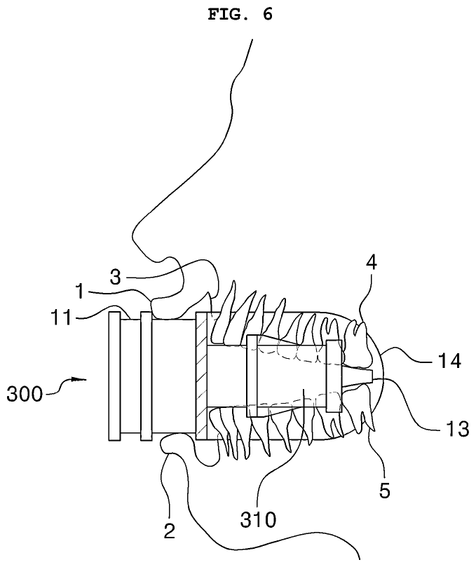

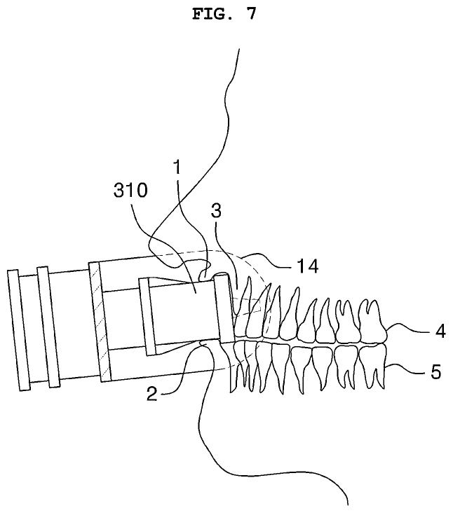

More specifically, FIG. 6 is a view for explaining a state in which the mouthpiece 300 is held in his/her mouth only for breathing.

Referring to FIG. 6, when the guide wing part 14 is inserted into a diver's oral cavity, the diver surrounds the outer circumferential surface of the fastening part 11 with the upper lip 1 and the lower lip 2, holds down the tooth occlusion part 13 with the molars in order to prevent the mouthpiece 300 from escaping to the outside of the oral cavity, and then breathes underwater.

In this case, the upper front teeth 4 and the lower front teeth 5 may lightly hold or touch the lip biting tube 110, but the upper front teeth 4 may not be placed on the inner surface of the lower lip 2.

That is, when the guide wings part 14 is inserted into the inside of opposite cheeks, bilabial sounds may not be pronounced.

However, as shown in FIG. 7, when the guide wing part 14 is spit out to the outside of the oral cavity, it is possible to pronounce bilabial sounds since the upper front teeth 4 may be placed on the inner surface of the lower lip 2 in a state in which the guide wing part 14 is located on the outside of cheeks 3 and a diver's lips 1, 2 may wrap and hold the outer circumferential surface of the lip biting tube 110.

That is, the mouthpiece 300 enables it possible to communicate accurately among divers underwater since a diver may breathe in the same way as the conventional mouthpiece 10 when the guide wing part 14 is inserted into the inside of opposite cheeks and may pronounce bilabial sounds while breathing when the guide wing part 14 is spit out to the outside of the oral cavity and the lip biting tube 110 is held with the upper lip 1 and the lower lip 2.

As described above, the present disclosure has been illustrated and described with reference to the preferred embodiments, but is not limited to the above embodiments and various changes and modifications may be made by those skilled in the art without departing from the spirit of the present disclosure.

What is claimed is:

1. An underwater communication device in which other divers may hear voices transmitted through water when one diver speaks holding the underwater communication device in his/her mouth, the underwater communication device comprising:
a casing which forms an interior space and has openings respectively provided on one side and the other side thereof;
a voice transmission member which is provided on one opening of the casing and transmits voices into the interior space of the casing when the diver holds the underwater communication device in his/her mouth and speaks; and
a vibration member which is in a shape of a horn with one side of a large diameter being opened and with the other side being closed, the other side of which is inserted into the other opening of the casing, an outer circumference of a one side end of which is screwed into an inner circumference of the other opening of the casing, and which transmits voices into the other side being opened by vibrating through voices transmitted into the interior space of the casing,
wherein the vibration member is configured to change a volume of the interior space of the casing by moving back and forth depending on an extent of screwing the outer circumference of the one side end thereof to the inner circumference of the other opening of the casing, and
a volume of the transmitted voice is changeable as the volume of the interior space of the casing is changeable.

2. The underwater communication device of claim 1, wherein the vibration member comprises:
a horn-shaped skeleton frame;
a carbon fiber plate that surrounds an outer circumference of the skeleton frame and is configured to vibrate by voice; and
a guide rod that extends backward from the other side of the skeleton frame and is inserted into a guide hole inside the casing so as to guide the skeleton frame and the carbon fiber plate without allowing shaking when the skeleton frame and the carbon fiber plate move forward and backward.

3. The underwater communication device of claim 2, wherein the interior space of the casing is provided with the vibration member therein, and is divided into a voice transmission space which transmits voices and an air emission space which emits air of the voice transmission space to an outside when a pressure inside the voice transmission space is more than a predetermined level of pressure,
a valve configured to emit air more than a predetermined level of pressure is provided at a location between the voice transmission space and the air emission space, and
the air emission space is provided with an air outlet that emits air to the outside and a mesh net that crushes air flowing into the air emission space into fine bubbles of air and emits the fine bubbles of air to underwater.

4. The underwater communication device of claim 3, wherein the underwater communication device fastens with a mouthpiece connection adaptor which connects a mouthpiece that a diver holds in his/her mouth and is supplied with air and a second respirator that supplies the mouthpiece with the air of an air tank to each other, and the mouthpiece connection adaptor is provided with a switch gear which selectively supplies the mouthpiece with the air of the second respirator or supplies the voice transmission member with the air spit by the diver when the diver speaks.

5. The underwater communication device of claim 4, wherein his/her mouthpiece comprises:
a fastening part which is cylindrical with an air inlet being penetrated through which air may flow from one side to the other side and whose one end fastens either with the second respirator which receives air from a first respirator of the air tank and then emits or with the mouth connection adaptor;
a guide wing part which extends from each of opposite sides of the other end of the fastening part and may be inserted in between an inner side of a diver's cheeks and teeth;
a tooth occlusion part which protrudes from an inner surface of each of the guide wing parts and which the diver may hold in his/her mouth with lower teeth and upper teeth so as prevent the guide wing parts from escaping from the oral cavity of the diver when the guide wing parts are inserted into the oral cavity; and
a lip biting tube which extends with a predetermined length from the other end of the fastening part, and is configured to supply the air from the fastening part to the oral cavity of the diver, and enables to pronounce bilabial consonants (labial sounds) by placing the upper teeth on an inner side of a lower lip whereas breathing while holding with lips when the diver spits the guide wing parts toward an outside of the oral cavity underwater, thereby allowing the diver to speak underwater while breathing.
